(19) United States
(12) Patent Application Publication
(10) Pub. No.: US 2007/0009784 A1
(43) Pub. Date: Jan. 11, 2007

(54) Materials system for intermediate-temperature SOFC based on doped lanthanum-gallate electrolyte

(76) Inventors: Uday B. Pal, Dover, MA (US); Srikanth Gopalan, Westborough, MA (US); Wenquan Gong, Boston, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/476,420

(22) Filed: Jun. 28, 2006

Related U.S. Application Data
(60) Provisional application No. 60/695,079, filed on Jun. 29, 2005.

(51) Int. Cl. H01M 4/86; H01M 8/12

(52) U.S. Cl. 429/45; 429/30

(57) ABSTRACT

The invention provides for a stable materials system for intermediate temperature solid oxide fuel cells (SOFC). Without limitation, a solid electrolyte layer can include a Sr-and-Mg doped lanthanum gallate layer, such as La_{0.9}Sr_{0.1}Ga_{0.8}Mg_{0.2}O₃, (LSGM), or a bi-layer semiconductor electrolyte (comprising, for example, donor doped SrTiO3 in an n-type first semiconductor layer and LSCF or LSM in a p-type second semiconductor layer); cathode materials can include La₁₋ₓSrₓMnO₃ (LSM), La₁₋ₓSrₓCo_{y}Fe_{1-y}O₃ (LSCF), a two-phase particulate composite consisting of LSM and LSGM (LSM-LSGM), and LSCF-LSGM composite; anode materials can include Ni—Ce_{0.85}Gd_{0.15}O₂ (Ni-GDC) and Ni—Ce_{0.6}La_{0.4}O₂ (Ni-LDC) composites; and a barrier layer of GDC or LDC can be used between the electrolyte and Ni-composite anode to prevent adverse reaction of the Ni in the anode layer with lanthanum in the electrolyte layer.

### CROSS REFERENCE TO RELATED APPLICATIONS

This application claims priority under 35 U.S.C. §119(e) to provisional patent application Ser. No. 60/695,079, filed Jun. 29, 2005, the disclosure of which is incorporated by reference.

### STATEMENT AS TO FEDERALLY SPONSORED RESEARCH

This invention was made with Government Support under Contract Number DE-FG26-02NT41539 awarded by the Department of Energy. The Government has certain rights in the invention.

### BACKGROUND

Solid oxide fuel cells (SOFCs) are comprised of a layered structure of a dense electrolyte sandwiched between porous and permeable electrodes (anode and cathode). They provide a very attractive and versatile means of efficiently converting chemical to electrical energy from a wide variety of fossil fuels with much lower environmental impact than conventional power generation systems such as those based on gas turbines. In particular, electrical power generation systems based on SOFCs have the following advantages: high power generation efficiency since chemical energy is directly converted into electrical energy, and there are negligible transmission and distribution losses; cogeneration capability, especially if they are operated at above atmospheric pressures, since the product gases have sufficiently high heat content; capability of operating on a wide variety of hydrocarbon fuels and generating much lower NOₓ and SOₓ levels since oxygen and hydrogen are electrochemically reacted; ability to internally reform hydrocarbon fuels because of the elevated operating temperature; high power-to-weight ratio since the fuel cell components are made of light-weight and relatively thin ceramic materials; noise-less operation; lower manufacturing time since the units are modular in nature and can be assembled on site; solid-state structures that can be easily transported; and wide range of applications that include stationary, transportation and military uses. More details are available in [1].

The material property requirements for SOFCs are quite stringent and well established [2-4]. The electrolyte must have adequate oxygen-ion conductivity (greater than 0.03 S/cm), negligible electronic conductivity, be stable in both oxidizing and reducing conditions and remain dense and impervious during cell operation. The porous and gas-permeable electrodes (anode and cathode) must have high electronic conductivity (greater than 170 S/cm) and charge transfer/surface exchange kinetics (greater than 10⁻⁷ cm/s), be stable in respective gas environments (oxidizing conditions for cathode and reducing for anode) and remain chemically, mechanically and structurally compatible with the electrolyte and interconnect materials. The interconnect (bi-polar separator plate) material must be an electronic conductor, remain dense and impervious in order to separate the anodic and the cathodic regions, be stable in both reducing and oxidizing conditions, and also be chemically, mechanically and structurally compatible with the anode and the cathode materials.

The most successful state-of-the-art high-temperature SOFCs are manufactured by Siemens-Westinghouse. They are tubular-cathode-supported SOFCs and operate at 900-1100° C., with fuel utilization of 80-90%, and power density in the range of 0.2-0.5 W/cm² [5]. The anode, electrolyte, cathode and interconnect materials are Ni-yttria-stabilized ZrO₂ cermet (electronic conductor), oxygen-ion-conducting yttria-stabilized zirconia (YSZ), Sr-doped lanthanum manganite (electronic conductor), and Mg, Ca and Al-doped lanthanum chromite (electronic conductor), respectively. The electrodes (anode and cathode) are 30-40% porous and permit molecular diffusion of gases, and the electrolyte and interconnect are dense. The cathode (1-2 mm thick) is fabricated by green extrusion followed by sintering, the electrolyte (20-40 μm thick) by the electrochemical vapor deposition (EVD) or a plasma spray process, the anode (100-150 μm thick) by slurry coating followed by sintering, and the interconnect (50-100 μm thick) by a plasma-spray process. The cost of producing fuel-cell stacks with these batch-processed cells is estimated to plateau, with all foreseeable improvements, at $1500/kWe [6]. This is still significantly (an order of magnitude) higher than their gas-turbine counterparts.

Another major difficulty, which presently limits the application of these SOFCs, is its high operating temperature range (900-1100° C.). The high temperature makes it necessary to use expensive high-temperature-corrosion-resistant manifolding materials, and high thermal-energy costs are associated with the initial heating of the system. Although once the cells start operating the heat generated in the process can sustain the temperature. Also, at these high temperatures, when operating the cells at current densities greater than 350 mA/cm², there are considerable interfacial reactions that occur at the electrode/electrolyte/interconnect interfaces. It causes cell degradation, and densification of the porous cathode and thus limits the operating life of the cell. Tremendous progress has been made in extending the life of SOFCs operating at 900-1100° C., to more than 16,000 hours with essentially less than 1% degradation in cell performance [7]. Therefore, if the operating temperature of the SOFCs is to be lowered, they must demonstrate similar or superior performance at lower temperature and have longer operating life. It is possible that a lower operating temperature can increase the operating life of the cells by reducing the interfacial reactions and decreasing the risk of delamination of the cell components during thermal cycling. However, it is not possible to decrease the operating temperature of the present high-temperature SOFC without sacrificing its electrical performance. For instance, a 300° C. decrease in the operating temperature from 1000° C. causes an order-of-magnitude increase of the zirconia electrolyte resistivity [2]. Therefore, if the operating temperature is lowered from 1000° C. to 700° C., an order of magnitude thinner electrolyte will be required to maintain similar ohmic loss. Such a thin electrolyte will cause the cell to lose its mechanical integrity and make it more susceptible to failure during operation. The electrode kinetics has a stronger exponential dependence on temperature and so employing the same electrodes at lower temperatures would result in significant polarization losses, particularly charge-transfer polarization losses at the electrode-electrolyte interfaces. This will drastically reduce the cell efficiency [3]. Hence, if the operating temperature of the SOFC is to be lowered, an entirely new material system for the electrolyte and the electrodes is needed.

It is clear that SOFCs are a very attractive and promising energy conversion technology. However, high processing cost and high operating temperatures are limiting the use of this technology. For commercial viability, there is a need to reduce the fuel cell stack processing cost to not exceed $400/kWe [6]. It is also necessary to identify new electrode-electrolyte materials in order to be able to decrease the operating temperature of the SOFC so that inexpensive manifolding materials can be used and the cost of the initial thermal energy required to heat the cells can be lowered. This work is directed towards the development of a new materials system for the SOFC that can enable lower operating temperatures (600-800° C.).

### SUMMARY

An embodiment of the invention provides for an intermediate temperature (600-800° C.) SOFC employing Sr and Mg-doped lanthanum gallate (LSGM), which offer a combination of highest ionic conductivity and materials stability under SOFC operating conditions. The invention provides for cathode materials comprising, inter alia, LSM, LSCF, and/or porous composite electrodes that comprise LSM-LSGM and LSCF-LSGM. An embodiment of the invention preferably has a cathode material for the LSGM electrolyte that comprises 50 vol % porous composite of LSCF-LSGM.

The invention provides for mixed conducting (ionic-electronic) cathode materials wherein polarization resistance can depend on cathode thickness.

Further embodiments provide for intermediate-temperature SOFCs wherein polarization of the cathode layer initially decreases sharply with increasing electrode thickness and then levels off asymptotically beyond a critical thickness of 40 μm. The invention provides for SOFCs wherein a critical thickness of the electrode can be a function of the electrode microstructure. One embodiment provides for fabricated cathodes preferably having a 1 μm average grain size and 30% porosity.

Various anode materials are provided for according to the invention. According to one embodiment a barrier layer can be applied to prevent direct contact and reaction of Ni with the LSGM electrolyte. A GDC barrier layer can allow lanthanum diffusion from the LSGM electrolytes. In one embodiment, LDC serves as an effective barrier layer between the LSGM electrolyte and the Ni-composite anode, because LDC has the same La chemical potential as in the LSGM, and the Ni in the anode does not react with lanthanum in the LDC barrier layer, which has a fluorite structure. Considering the chemical reactivity and thermal expansion coefficients, the Ni-LDC composite anode with a thin LDC barrier layer is a most preferred anode material systems choice for the LSGM electrolyte.

Further preferred embodiments of the invention provide for a LSGM electrolyte supported SOFC comprising NI-GDC anode, LDC barrier layer between the anode and the electrolyte, LSGM electrolyte, and LSCF-LSGM composite cathode. An embodiment provides for a cell having a maximum power density of 190 mW/cm² at 800° C. and 3 mW/cm² at 600° C.

A further embodiment provides an anode-supported SOFC based on 20 μm-thick LSGM electrolyte, employing a graded electrode structure, having a maximum power density that can reach 927 mW/cm² at 800° C. and 239 mW/cm² at 650° C. Preferably, SOFCs according to the invention achieve power densities in the range 0.2 to 1 W/cm² between 650-800° C.

Another embodiment provides for a solid oxide fuel cell having a low cell-to-cell resistance, the cell comprising a cathode layer, a ceramic bi-layer interconnect consisting of a dense p-type semiconductor material layer adjacent at a bi-layer interface to a dense n-type semiconductor material layer, wherein the p-type semiconductor layer is adjacent to the cathode layer, a barrier layer adjacent to the ceramic bi-layer opposite the cathode layer, and an anode layer adjacent to the flexible metal structure layer opposite the ceramic bi-layer.

### BRIEF DESCRIPTION OF THE DRAWINGS

The invention is described with reference to the following drawings which are provided for the purpose of illustration only and are not intended to be limiting of the invention.

FIG. 1 illustrates a bi-layer ceramic interconnect structure for SOFCs according to an embodiment of the invention.

FIG. 2 illustrates a temperature dependence of the conductivity of LSGM electrolyte according to an embodiment of the invention measured using the four-probe technique.

FIG. 3 illustrates a schematic of the setup employing symmetrical cells for impedance measurements to evaluate electrode performance.

FIG. 4 illustrates a schematic of a setup employing LSGM-electrolyte-supported SOFCs according to an embodiment of the invention for measuring electrical performance.

FIGS. 5(a)-5(d) illustrate SEM micrographs (scale bar is 20 μm) of fracture surfaces of cathode/electrolyte interfaces: 5(a) LSM above, LSGM below; 5(b) LSM and LSGM above, LSGM below; 5(c) LSCF above, LSGM below; 5(d) LSCF and LSGF above, LSGM below.

FIG. 6 illustrates an impedance plot of an LSGM symmetrical cell according to an embodiment of the invention with identical electrodes (cathode/anode) at 800° C.

FIG. 7 illustrates a temperature dependence of the polarization resistance for various cathode materials according to an embodiment of the invention measured in air.

FIG. 8 illustrates a plot of interfacial polarization resistance as a function of electrode thickness for symmetrical LSCF/LSGM/LSCF cells according to an embodiment of the invention measured in air at 800° C.

FIG. 9 illustrates a time dependence of ohmic and polarization resistances of symmetrical Ni-GDC/LSGM/Ni-GDC cell according to an embodiment of the invention measured at 800° C.

FIG. 10 illustrates a diffusion profile of lanthanum in the GDC barrier layer as a function of processing temperature.

FIG. 11 illustrates time dependence of the interfacial polarization resistances of cermet anodes with and without the LDC barrier layer over LSGM electrolyte at 800° C.

FIGS. 12(a)-(b) illustrate SEM micrographs of the polished cross sections of the cathodic and anodic sides of an LSGM electrolyte supported SOFC according to the invention that was electrochemically evaluated, with an LDC barrier layer deposited on the anodic side: 12(a) LSCF-LSGM cathode above, LSGM electrolyte below; 12(b) Ni-LDC anode above, LDC barrier layer middle, LSGM electrolyte below.

FIG. 13 illustrates electrical performance of LSGM-electrolyte-supported (1 mm thick electrolyte) SOFC with an LDC barrier layer on the anodic side.

FIG. 14 illustrates electrode polarization modeled from electrical performance data at 800° C. of LSGM-electrolyte-supported (1 mm thick electrolyte) SOFC with an LDC barrier layer on the anodic side.

FIG. 15 illustrates stability of an LSGM-electrolyte-supported SOFC with an LDC barrier layer on the anodic side (operating at 800° C.).

FIG. 16 illustrates a preferred structure of the anode-supported Intermediate Temperatures SOFC based on the LSGM electrolyte according to an embodiment of the invention.

FIG. 17 illustrates simulated electrical performance of an anode-supported SOFC based on the LSGM electrolyte (20 μm thick) with a LDC barrier layer on the anodic side

FIG. 18 illustrates a comparison of conductivities as a function of temperature of various oxygen-ion-conducting solid electrolytes according to embodiments of the invention.

### DETAILED DESCRIPTION

For SOFC stack fabrication, interconnects (ICs) are needed to electrically connect the cathode of one SOFC to the anode of another SOFC. The interconnect material thus needs to be an electronic conductor that is stable in both reducing and oxidizing conditions. Since a stable metallic interconnect (IC) is currently not available for SOFCs, a preferred embodiment of the invention further provides for using a ceramic bi-layer structure consisting of a p-type semiconductor layer exposed to cathodic gas (air/oxygen) and an n-type semiconductor layer exposed to anodic gas (fuel). The oxygen partial pressure at the interface between the bi-layers is an important design variable for maintaining structural stability and a high level of electronic conductivity within the bi-layer interconnect. The oxygen partial pressure at the bi-layer interface is dependent primarily on the oxygen partial pressure gradient across the bi-layer interconnect, the low level oxygen conductivities of the two layers and is largely independent of their electronic conductivities and the total current density through the interconnect material [See: “Bi-Layer Structures as Solid Oxide Fuel Cell Interconnections”, W. Huang and S. Gopalan, J. Power Sources 154 (2006) 180-183, herein incorporated by reference in its entirety]. By careful design of the composition and thicknesses of the two layers, embodiments of the invention provide an IC with a low cell-to-cell resistance.

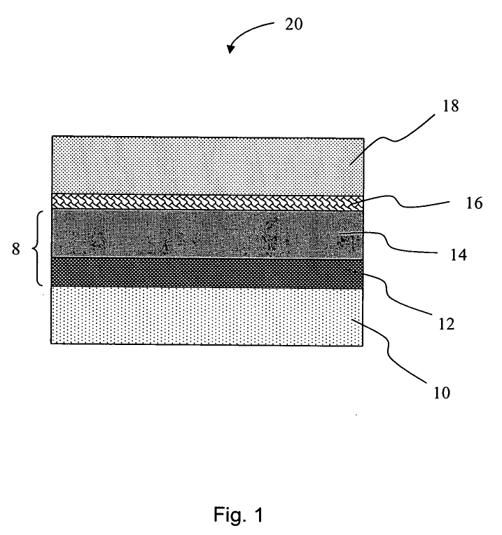

Referring to FIG. 1, an embodiment of the invention utilizing a bi-layer interconnection for the LSGM-electrolyte supported SOFC 20 is depicted. The embodiment provides for a bi-layer structure 8 comprising one p-type semiconductor layer 12, such as, for example, LSCF or LSM, and one n-type semiconductor layer 14, such as, for example, Gd_{0.08}Sr_{0.88}Ti_{0.95}Al_{0.05}O_{3±δ} (GSTA) or La_{0.08}Sr_{0.88}Ti_{0.95}O_{3±δ}(LSTA), where δ is the nonstoichiometry on the oxygen lattice which depends on temperature, Gd or La dopant level and oxygen partial pressure. In an LSGM electrolyte supported SOFC 20 according to one embodiment, the p-type semiconductor layer 12 of the bi-layer interconnection is in contact with an LSCF-LSGM composite cathode 10 which is exposed to an oxidizing environment and the n-type semiconductor layer 14 will be in contact with Ni-GDC or Ni-LDC in a barrier layer 16 or, if a barrier layer is absent, in the anode 18 exposed to reducing conditions (fuel). GDC, GSTA and Ni are mutually compatible materials for these applications. During operation of the cell, the dense p-type semiconductor layer 12 exposed to the cathodic side will develop p-type conductivity and the dense n-type semiconductor layer 14 exposed to the anodic side will develop n-type conductivity. The structure according to this embodiment provides an excellent SOFC interconnection, maintaining a high electronic conductivity across its thickness. In general, examples of p-type semiconductor materials include acceptor doped-lanthanum manganite, such as, for example, lanthanum strontium manganate (LSM), doped-lanthanum ferrite, doped-lanthanum chromite and doped-lanthanum cobaltite, including Sr and Fe doped lanthanum cobaltite, which can further include lanthanum strontium cobalt ferrite (LSCF). In general, examples of n-type semiconductor materials include A- and B-site donor doped strontium titanate, including, for example, Gd_{0.08}Sr_{0.88}Ti_{0.95}Al_{0.05}O_{3±δ} (GSTA) or La_{0.08}Sr_{0.88}Ti_{0.95}Al_{0.05}O_{3±δ} (LSTA). It will be appreciated that these examples of materials producing p-type and n-type semiconductivity according to the invention are for purposes of illustrating preferred embodiments and are not meant to limit the scope of the invention thereto; other known p-type and n-type semiconductor materials could be used in the bi-layer interconnect in accordance with the invention.

The invention further provides for a range of choices of electrode materials for an Intermediate-Temperature SOFC. Performance of some complete cells in accordance with the invention is described in terms of the polarization resistance of several anode and cathode materials for application in Intermediate-Temperature (600-800° C.) SOFCs employing LSGM electrolyte. Preferred cathode and anode materials systems offer superior performance in terms of the polarization resistance for these applications. Cathode materials according to some embodiments include state-of-the-art electrode materials for YSZ electrolyte SOFCs (such as, for example, La₁₋ₓSrₓMnO₃, or LSM), Sr and Fe doped lanthanum cobaltite (such as, for example, La₁₋ₓSrₓCo_{y}Fe_{1-y}O₃, or LSCF), and two porous composite electrodes, one comprising a two-phase particulate mixture of LSM-LSGM and the other consisting of LSCF-LSGM. The cathode materials have adequate electronic conductivity to function as a cathode.

The interfacial polarization resistance of the cathode materials as a function of temperature influences their selection for application in the intermediate-temperature SOFCs.

The choice of anode materials can include Ni-doped ceria composites. Nickel is a well-known SOFC anode material, and acts as the fuel side electrocatalyst and current collector. The SOFC anodes can be prepared by mixing and sintering NiO and an oxygen-ion-conducting oxide in air, followed by reducing the NiO to Ni under reducing conditions. Lanthanum or gadolinium doped ceria can be used as the oxygen-ion-conducting oxide in the anode in order to buffer the thermal expansion mismatch between the anode and the electrolyte and to lower the charge-transfer polarization, owing to its mixed-conducting property; La-or-Gd-doped ceria conducts both oxygen ions and electrons. To overcome the challenge of the Ni phase in the anode reacting with the perovskite LSGM phase, thus forming an insulating lanthanum nickelate phase and causing the ohmic and anodic polarization resistances to increase with time, a lanthanum or gadolinium doped ceria barrier or buffer layer can be applied to prevent direct contact and reaction of Ni with the LSGM electrolyte. Since the doped ceria has sufficiently high oxygen-ion conductivity and the buffer layer is preferably thin (less than 5 μm), the ohmic polarization resistance of the cell need not increase.

According to one embodiment of the invention the microstructure of the composite cathode and anode is crucial to achieving high power densities while operating the cell. Fine microstructure, fine connected porosity and well-dispersed ionic and electronic conductors are most preferred for a good electrode exhibiting low charge-transfer or interfacial polarization. The effective charge-transfer resistance scales as the square root of the grain size of the electrode material. However, there is a limit to the acceptable pore size. When the electrode pore size is comparable to the mean free path of the gases being transported in and out of the electrodes, the cell performance is dominated by concentration (mass-transfer) polarization. According to an embodiment of the invention, to achieve a balance between these two conflicting requirements, graded electrode structures with a finer microstructure and porosity close to the electrolyte and coarser microstructure and larger porosity away from the electrolyte can be provided for the supporting electrode. For instance, for an anode-supported SOFC, the fine electrode microstructure close to the electrolyte can have a large three-phase-boundary (ionic-electronic-gas) length and facilitate charge-transfer reactions and the coarser microstructure and porosity of the thicker outer anode layer can facilitate gas transport. According to one embodiment of the invention a fine microstructure is needed at the electrode interface with the electrolyte.

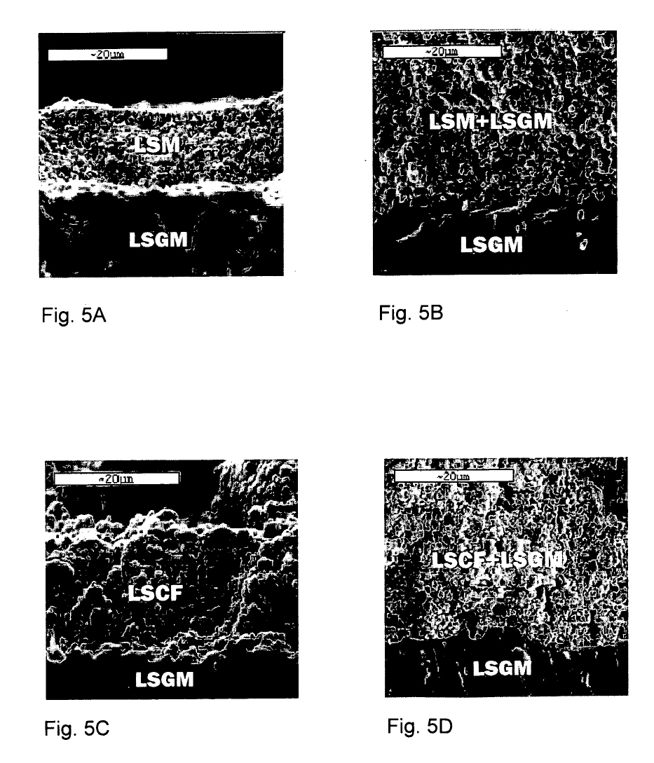

Fractured surfaces of the LSM, LSM-LSGM, LSCF, LSCF-LSGM, Ni-GDC, and Ni-LDC electrodes and their interfaces with the electrolyte/barrier layer show that these electrodes have similar microstructures in terms of their interfacial adherence with the LSGM electrolyte, porosity and grain size. The grain size of the electrodes is preferably on the order of 1-2 μm and the porosity is preferably between 25-35% measured in terms of percentage area of the pore in cross section (such as, for example, from the micrographs using ADOBE PHOTOSHOP® software). Sample cross sections of the fractured surfaces of various electrode/electrolyte interfaces are shown in FIG. 5. The thickness of the electrodes is preferably 10-60 μm. Based on the grain size, porosity and thickness of the electrodes, gas diffusion does not control the interfacial polarization process, particularly for small applied potentials that are used for AC impedance measurements.

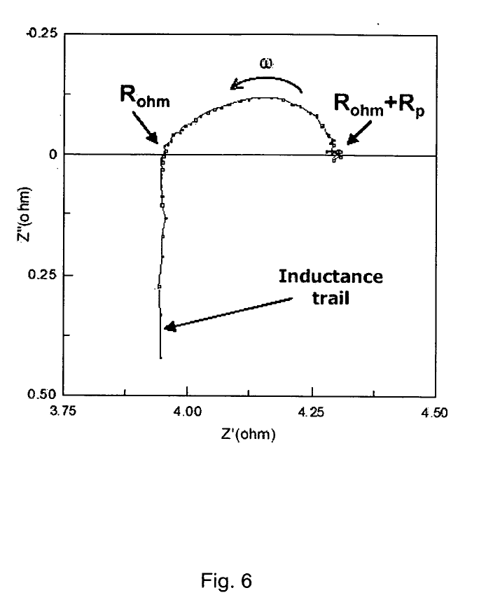

A typical impedance plot measured using a symmetrical cell arrangement according to an embodiment of the invention is shown in FIG. 6. For all samples measured a single depressed arc was observed. The high-frequency intercept of the impedance spectrum gives the ohmic resistance of the cell (Rₒₕₘ) which includes the resistive contributions of the electrolyte, the two electrodes, the current collectors and the lead wires. The low-frequency intercept gives the total resistance (Rₒₕₘ+Rₚ), which includes the ohmic resistance of the cell, concentration polarization (or mass transfer polarization) resistance and the effective interfacial polarization resistance (R^{eff}_{redox}). The total polarization resistance of the electrode (Rₚ) is then extracted by subtracting the high-frequency intercept from the low-frequency intercept on the impedance plot. Given that the electrodes are thin, the amplitude of the applied AC voltage is small (10 mV), and the gas flow over the electrode is continuous; thus, it is most likely that the effective interfacial polarization resistance, R^{eff}_{redox}, dominates the polarization resistance for the electrodes, i.e., the concentration polarization is negligibly small and Rₚ is essentially equal to R^{eff}_{redox}.

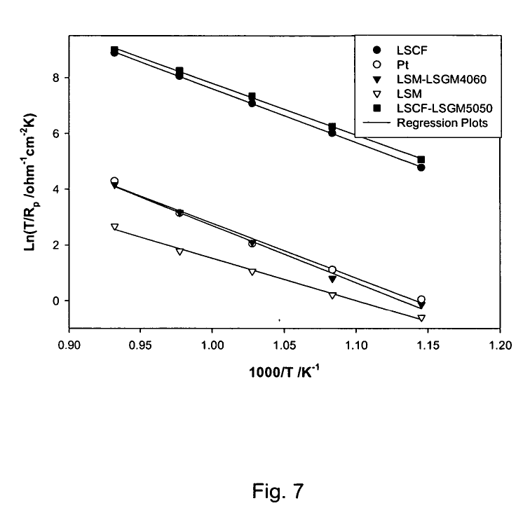

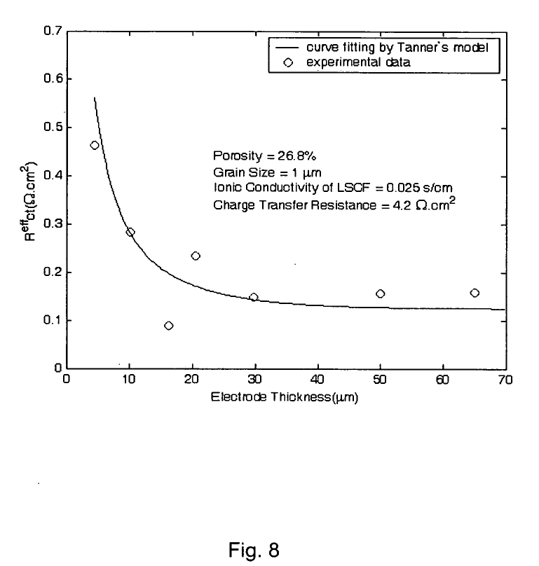

In order to lower the interfacial polarization according to one embodiment of the invention the electrode needs to be a mixed conductor (have both electronic and oxygen ion conductivities). Since LSM is a p-type semi-conductor, it is advantageous to provide the oxygen-ion conductivity by mixing it with LSGM. On the other hand, since the LSCF is already a mixed conductor, mixing it with LSGM does not significantly lower the interfacial polarization. However, there is approximately 50% mismatch in thermal expansion coefficient between the LSCF electrode material (19.5×10⁻⁶/K) and LSGM electrolyte material (11.6×10⁻⁶/K). Therefore, from the point of view of lowering the interfacial thermal stresses it is desirable to have a LSCF-LSGM composite electrode as the cathode. According to alternative embodiments of the invention, several cathode materials, such as, for example, LSM, LSCF, LSM-LSGM and LSCF-LSGM composite electrodes can be used in the Intermediate Temperature (IT)-SOFCs based on the LSGM electrolyte. FIG. 7 shows a comparison of the polarization resistances of the above cathode materials as a function of temperature, measured using impedance spectroscopy on symmetric cells. The polarization resistance is plotted as inverse resistance versus inverse temperature. According to a preferred embodiment having cathode materials compatible with LSGM electrolyte, a 50 vol % LSCF-LSGM porous composite is a most preferred cathode material. As can be seen from FIG. 7, the composite 50 vol % LSCF-LSGM cathode has an interfacial polarization resistance that is several orders of magnitude lower than that of the LSM-LSGM composite cathode and the interfacial polarization resistance of the LSM-LSGM composite is lower than that of the conventional single-phase LSM electrode. The interfacial polarization resistance of the LSCF-LSGM composite cathode is also slightly lower than for the single-phase LSCF cathode. In addition, considering the thermal expansion coefficient (TEC) mismatch between the LSCF cathode and LSGM electrolyte, the LSCF-LSGM composite is preferred over the single phase LSCF material. In mixed-conducting cathode materials, there exists a dependence of polarization resistance on electrode thickness. The polarization resistance of LSCF cathode on LSGM electrolyte is shown in FIG. 8 as a function of thickness. The polarization of the cathode layer initially decreases sharply with increasing electrode thickness and then levels off asymptotically. Results of performance evaluations of embodiments according to the invention, shown in FIG. 8, agree well with the following mathematical model:

$$\begin{matrix}{R}_{P} = {R}_{ct}^{eff} = \frac{{LR}_{ct}}{\begin{matrix}( \frac{1 + β}{1 + β {ⅇ}^{- 2 \frac{h}{α}}} ) ( 1 - p ) L {ⅇ}^{- \frac{h}{α}} + \\ ( \frac{1 + β {ⅇ}^{- \frac{h}{α}}}{1 + β {ⅇ}^{- 2 \frac{h}{α}}} ) α ( 1 - {ⅇ}^{- \frac{h}{α}} ) + pL\end{matrix}} \\ where & ( 4 ) \\ α = \sqrt{{σ}_{{O}^{2 -}} L ( 1 - p ) {R}_{ct}} \\ and \\ β = \frac{{σ}_{{O}^{2 -}} {R}_{ct} - α}{{σ}_{{O}^{2 -}} {R}_{ct} + α} & ( 5 )\end{matrix}$$

in which σ_{O}_{^{2−}} is the ionic conductivity of the electrode; h is the electrode thickness; p is the porosity of the electrode; L is the grain size of the electrode; R_{ct} is the intrinsic charge transfer resistance given by

$${R}_{ct} = \frac{RT}{{ZFi}_{0}} ; \qquad ( 6 )$$

Z is the number of electrons participating in the electrode reaction; F is the Faraday constant; R is the gas constant, and T is the temperature.

R_{ct} is a function of the electrochemical properties of the electrode/electrolyte pair, and also a function of the microstructure features of the electrode. R_{ct} is treated as an empirical parameter, determined experimentally for a given electrocatalyst/electrolyte pair.

FIG. 8 shows that increasing the electrode thickness has the effect of decreasing the effective interfacial polarization resistance. FIG. 8 also shows a fit to the data employing the mathematical model of Eq. 4 The fitting parameters are shown in Table 1.

TABLE 1
Curve fitting parameters for modeling electrode polarization
as a function of electrode thickness

| σ_{O}_{^{2−}} (s/cm) | L (μm) | p | R_{ct}(Ω · cm²) |
|---|---|---|---|
| 0.025 | 1 | 26.8% | 4.2 |

The initial decrease of the cathode polarization resistance can be rationalized on the premise that increasing the electrode thickness results in an increase in the number of electrochemical reaction sites, i.e., total three-phase boundary length in the case of composite cathodes according to one embodiment of the invention, or total pore area in the case of mixed ionic-electronic conductors according to alternative embodiments of the invention. The subsequent leveling off of the polarization resistance is due to the fact that, above a certain critical electrode thickness, the migration of the oxygen ions from the reaction sites to the electrode/electrolyte interface become rate controlling. Thus, there is a certain critical thickness beyond which the cathodic polarization resistance shows no further decrease with increasing thickness. This critical electrode thickness is a strong function of the microstructure (grain size) and porosity, i.e., the finer the microstructure and the finer the porosity, the smaller is the critical thickness. Based on cathode microstructure according to one embodiment, a thickness of 40 μm is sufficient to minimize the interfacial polarization resistance; thus, the cathode layer is most preferably about 40 μm thick.

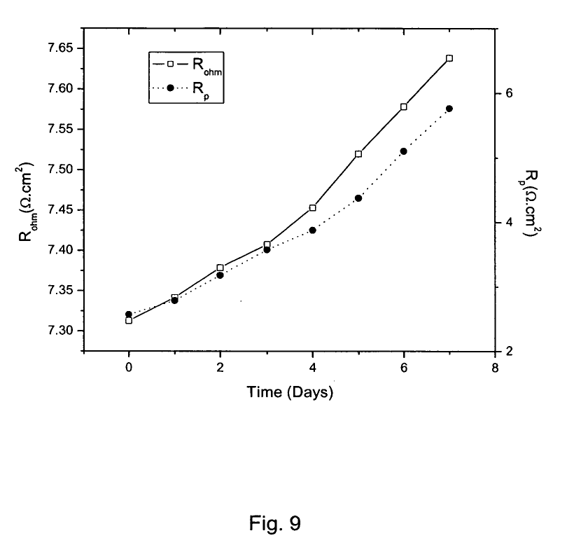

Nickel is a well-known SOFC anode material, and acts as the fuel side electrocatalyst and current collector in a further embodiment. Gadolinium doped ceria (GDC) is an excellent oxygen-ion conductor, is chemically and mechanically compatible with the lanthanum strontium gadolinium manganate (LSGM) electrolyte and has electronic conductivity under reducing conditions. Therefore, in an embodiment, Ni-GDC cermet is an effective anode so long as its reaction with the LSGM electrolyte can be prevented. The reactivity of the Ni-GDC cermet anode with the LSGM electrolyte can be evaluated by using a Ni-GDC/LSGM/Ni-GDC symmetrical cell at 800° C. under a reducing atmosphere (H₂-bubbled through 25° C. water bath). In such an evaluation, both the ohmic and interfacial polarization resistances increase gradually with time, which is shown in FIG. 9. These results confirm that Ni reacts with the LSGM and forms insulating phases (such as, for example, lanthanum nickelates) at elevated temperatures. Therefore, an embodiment of the invention provides further for using a layer of doped ceria between the LSGM electrolyte and Ni-GDC anode, in order to prevent direct contact between the Ni in the anode with the lanthanum in the LSGM electrolyte.

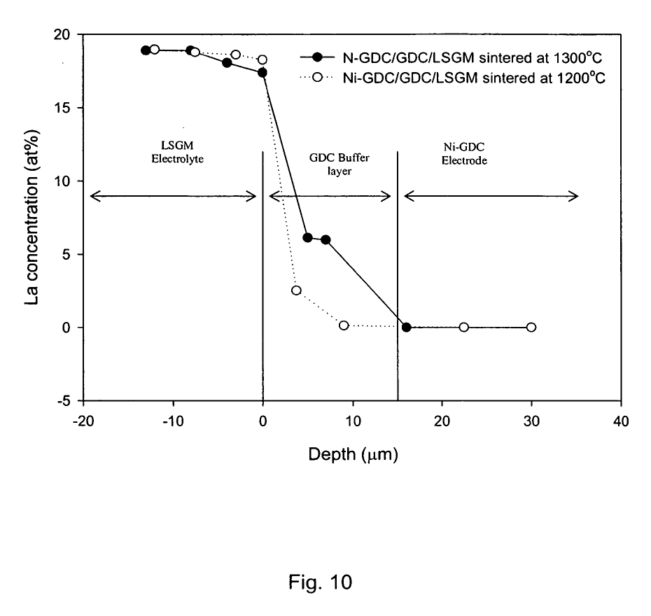

Examples of an embodiment of the invention combining Ni-GDC electrodes with a GDC barrier (buffer) layer on an LSGM electrolyte can be analyzed with wavelength-dispersive-spectroscopy (WDS) to show that the GDC barrier (buffer) layer allows lanthanum to diffuse from the LSGM electrolytes (FIG. 10). Lanthanum diffusion from LSGM into GDC leads to the formation of Ce_{1-x-y}LaₓGd_{y}O₂ solution in the GDC barrier layer and formation of resistive phases LaSrLa₃O₇ or LaSrGaO₄ at the LSGM electrolyte interface. The latter (formation of resistive phases) significantly increases the ohmic resistance of the cell. By decreasing the sintering temperature of the GDC buffer layer it is possible to decrease the lanthanum diffusion, but this leads to incomplete densification and poor interfacial adherence of the GDC buffer layer to the LSGM electrolyte. This also causes penetration of the Ni-GDC anode slurry into the LSGM electrolyte surface through the porous GDC barrier layer. This results in a time-dependent increase of the ohmic and interfacial polarization resistances similar to when the GDC barrier layer was absent. Thus, the GDC barrier layer between the LSGM electrolyte and the Ni-GDC composite anode is less than an LDC preferred barrier (buffer) layer.

An embodiment of the invention also provides for Ni-GDC and Ni-LDC electrodes with an LDC barrier (buffer) layer on an LSGM electrolyte. In this embodiment, lanthanum doped ceria (LDC) is employed as the barrier layer between the LSGM electrolyte and the Ni-composite anode in order to limit or eliminate lanthanum diffusion from the LSGM electrolyte into the barrier layer. The object here is to eliminate the lanthanum chemical potential gradient at the interface that results in lanthanum diffusion. Unlike the LSGM electrolyte which has a perovskite phase, the LDC barrier layer has a fluorite structure. The Ni in the anode does not react with the lanthanum in the LDC barrier layer so long as the La content in the LDC is below 50 mole % in the cationic site. Unlike the GDC barrier layer, when the LDC barrier layer has 40 mole % La in the Ce site and is sintered at 1300° C., there is no detectable La diffusion from the LSGM electrolyte. The 40 mol % Lanthanum doped ceria (LDC) is thought to have the same La chemical potential as in the LSGM and therefore prevents the La diffusion between LSGM electrolyte and the LDC buffer layer. Also since the La content in the LDC barrier layer is below 50 mole %, it was expected to be stable in contact with the Ni-composite anode.

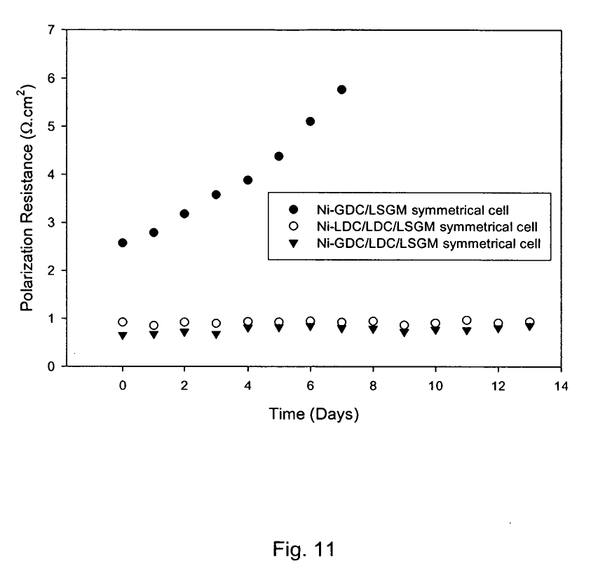

With LDC employed as the barrier layer, a further embodiments can utilize Ni-LDC composite or Ni-GDC composite in the anode layer. For these embodiments, time dependence of the interfacial polarization resistance at 800° C. of the LSGM symmetrical cells with Ni-LDC and Ni-GDC composite electrodes (such as, for example, anodes) with an LDC barrier layer is shown in FIG. 11. Also shown in the same figure, for comparison, is the interfacial polarization resistance of the Ni-GDC composite electrode (such as, for example, the anode) without the barrier layer. The interfacial polarization resistances of both Ni-LDC and Ni-GDC electrodes with an LDC buffer layer are stable over a period of two weeks, whereas the interfacial polarization resistance of the Ni-GDC electrode without the LDC buffer layer increases continuously with time owing to the reaction between Ni and the lanthanum in the LSGM electrolyte. Therefore, from the point of view of chemical reactivity and thermal expansion coefficients, a preferred embodiment utilizes Ni-LDC as the composite anode for the LSGM electrolyte with the LDC barrier layer.

While the embodiments of the invention described above have been discussed with respect to performance in the intermediate temperature range of about 600-800° C., further embodiments according to the invention can be used in high-temperature SOFC applications as well, i.e., in applications exceeding 800° C.

For the purpose of demonstrating performance and ease of fabrication, LSGM electrolyte supported SOFCs according to one embodiment of the invention with the most optimal cathode and anode materials system including a barrier layer between the electrolyte and the anode were electrochemically evaluated between 600-800° C. The results of the electrolyte-supported SOFC were used to simulate the electrical performance of the anode-supported SOFC with the selected materials system.

Complete LSGM electrolyte supported SOFCs according to an embodiment of the invention were fabricated for electrochemical evaluation. The cell components had the following dimensions and compositions:
(a) 1 mm thick dense LSGM electrolyte.
(b) dense adherent barrier layer (5 μm) of lanthanum doped ceria (LDC) between the LSGM electrolyte and the anode.
(c) 50% by volume of Ni-LDC composite anode having a thickness of 30-40 μm and porosity of 25-35%.
(d) 50% by volume of LSCF-LSGM composite cathode having a fine microstructure (1-2 μm grains), with a porosity of 25-35% and thickness of 30-40 μm.

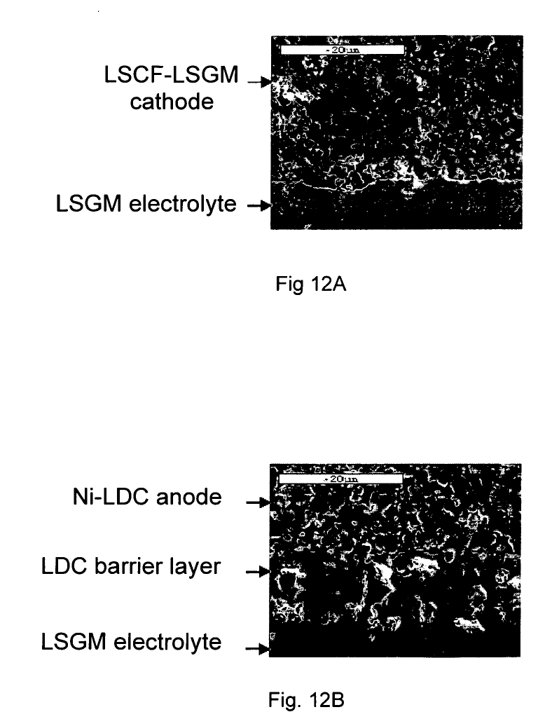

The SEM micrographs of the polished cross section of an LSGM electrolyte supported SOFC are shown in FIG. 12. The tested cell had porous electrodes, dense electrolyte and well-bonded cell components. An LDC barrier layer that was not always fully dense, but which had closed porosity, performed adequately.

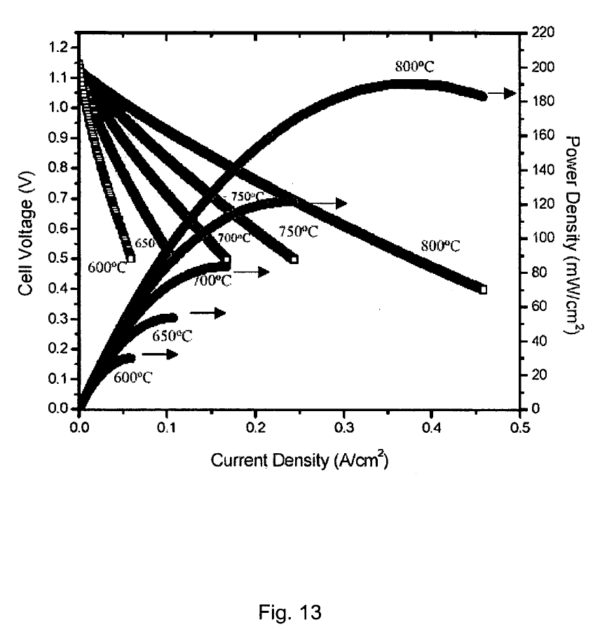

The open-circuit voltages (OCV) at a given temperature in the tested cell are very close to the Nernst potential determined by the equation

$$OCV = \frac{RT}{4 F} ln ( \frac{{P}_{{O}_{2} ( c )}}{{P}_{{O}_{2} ( a )}} ) \qquad ( 7 )$$

where P_{O}_{_{2(c)}} is the oxygen partial pressure on the cathode side and is 0.21 atm for air. P_{O}_{₂₍ₐ₎} is the oxygen partial pressure on the anode side and is fixed by the H₂O to H₂ ratio at a given temperature. The calculated theoretical OCV for the cell at 800° C. is 1.126V when hydrogen is bubbled through water at 25° C. (1.8% water vapor). The measured OCV at 800° C. was 1.118V, which was very close to the theoretical value. This result indicates good cell sealing. Shown in FIG. 13 is the dependence of the single cell voltages and power densities of the LSGM electrolyte-supported cell as a function of the current densities tested at 600° C., 650° C., 700° C., 750° C. and 800° C. The maximum power density ranges from 190 mW/cm2 at 800 C to 30 mW/cm2 at 600° C.

Performance Model for the LSGM Electrolyte Supported Cells: Single cell evaluations were conducted on electrolyte-supported SOFCs, resulting in current densities below 500 mA/cm². Both electrodes (cathode and anode) had high porosity and their thicknesses were small (around 30-50 μm), so the concentration polarization was negligible. When the polarization is large or at higher current densities, the relationship between the cell voltage and current density can be fitted by the following equation:
E_{cell}=OCV−i×Rₒₕₘ−(a+b×1ni) (8)

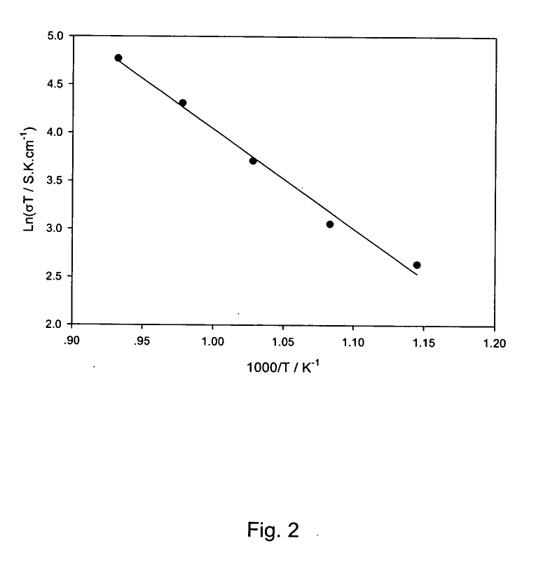

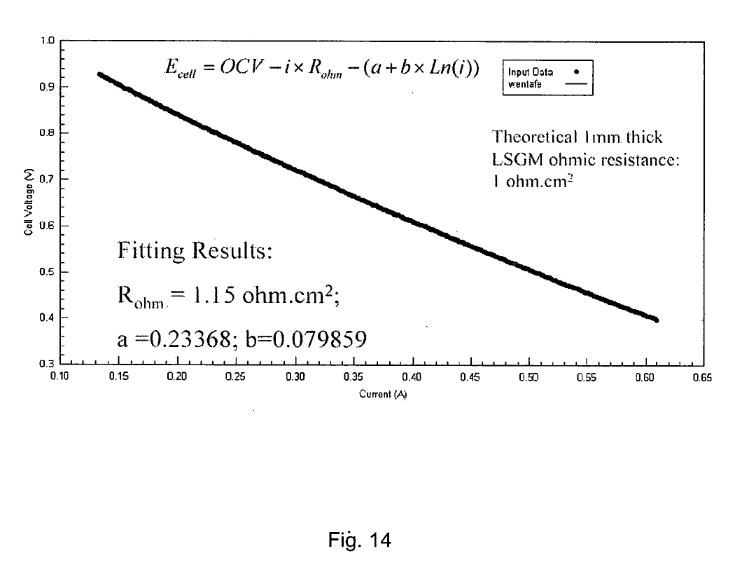

The evaluation data were fitted to the above equation with three parameters, namely, Rₒₕₘ, a, and b. As seen in FIG. 14, Eq. 8 fit the experimental data well at 800° C. Similar fits were obtained at other temperatures. Table 2 gives the parameters Rₒₕₘ, a, and b corresponding to the curve fitting results at other temperatures (from 650° C. to 800° C.). Rₒₕₘ, primarily consists of the ohmic resistances of the electrolyte, anode, cathode, current collectors, and the interfacial resistances between the electrodes and the electrolyte. The electrolyte resistance, Rₑ₁, can be calculated according to the thickness (1 mm) and the ionic conductivity measured by the four-probe method (FIG. 2). It can be seen from Table 2, that Rₑ_{₁} is a major portion of Rₒₕₘ.

TABLE 2
Curve fitting parameters for modeling electrode polarization

| Temperature | Rₒₕₘ (Ω · cm²) | a | b | Rₑ₁ (Ω · cm²) |
|---|---|---|---|---|
| 800° C. | 1.148 | 0.23368 | 0.07986 | 1 |
| 750° C. | 1.8 | 0.2795 | 0.08777 | 1.43 |
| 700° C. | 2.45 | 0.3566 | 0.0988 | 2 |
| 650° C. | 3.972 | 0.3415 | 0.07666 | 3.353 |

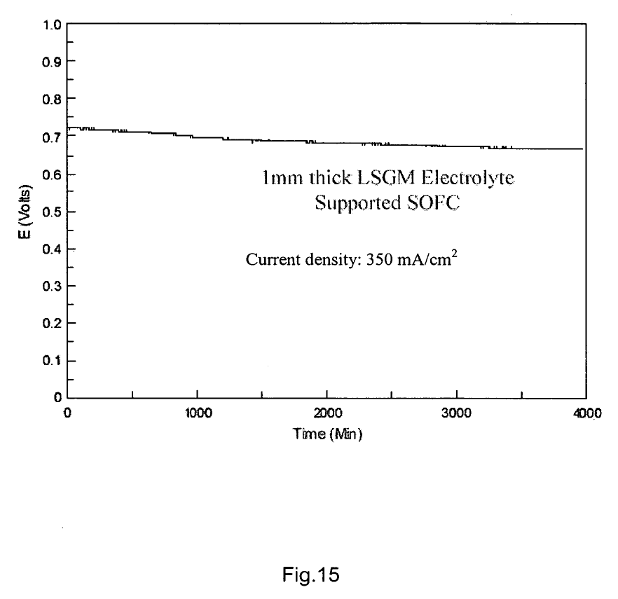

The performance stability of the LSGM electrolyte supported SOFC according to an embodiment of the invention can be evaluated by operating the cell at 800° C. starting with 0.72 V and a current density of 350 mA/cm². There is an initial 5% decay in the performance, but the cell appear to stabilize after 3500 minutes (FIG. 15).

According to a further embodiment higher power densities can be achieved with anode or cathode supported SOFCs rather than with the electrolyte supported SOFC. Such a cell can have the following cell-component dimensions:
(a) 50% by volume of Ni-LDC composite anode having a fine microstructure near the LDC buffer layer and coarser microstructure away from the barrier (buffer) layer; porosity 25-35%. Since the design is based on an anode-supported cell, the anode can be 1-2 mm thick and the fine microstructure region at least 30-40 μm thick.
(b) a dense adherent barrier layer (5 μm) of lanthanum doped ceria (LDC) between the LSGM electrolyte and the anode.
(c) 10-20 μm thick dense LSGM electrolyte.
(d) 50% by volume of LSCF-LSGM composite cathode having a fine microstructure (1-2 μm grains), porosity of 25-35% and thickness of at least 30-40 μm.

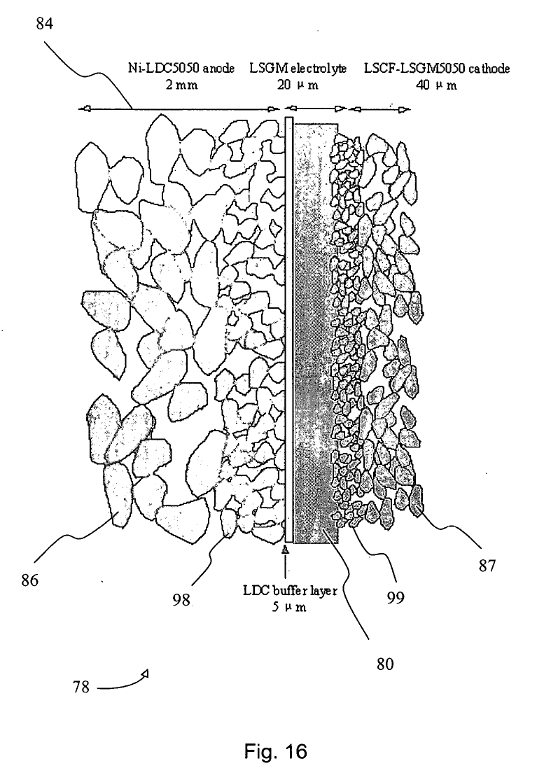

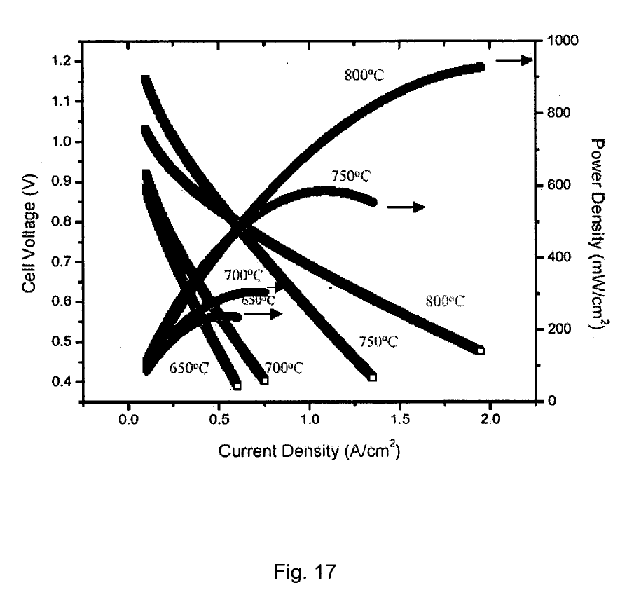

The cell structure is schematically shown in FIG. 16. The cell performance of this anode-supported SOFC 78 based on the LSGM electrolyte 80 can be simulated using the experimental results from the tested LSGM electrolyte-supported SOFC, because both cells consist of the same electrolyte and electrode materials. The only difference is the thickness of electrolyte 80 and anode 84. The thickness of the electrolyte is 1 mm for the electrolyte-supported cell, but is 20 μm for the anode-supported cell 78 depicted in FIG. 16, while the thickness of the anode is around 30 μm for the electrolyte-supported cell, but is 1-2 mm for the anode-supported cell. The change in thickness of the electrolyte will only influence the ohmic resistance of the electrolyte, Rₑ_{₁}, and the changing thickness of anode will only influence the concentration polarization of the cell. The anode-supported cell according to a preferred embodiment will use a graded electrode structure, i.e., coarser connected porosity 86, 87 away from the electrolyte-electrode interface to facilitate gas transport and finer connected porosity 98, 99 close to the electrolyte-electrode interfaces to aid in the charge-transfer reactions. The most preferred embodiment of an anode-supported SOFC 78 thus has negligible concentration polarization and the electrode polarization behavior will be similar to the electrolyte supported SOFC. Therefore, the difference between the tested electrolyte-supported cell according to one embodiment and the anode-supported cell of the most preferred embodiment is only in the ohmic resistance of the electrolyte, while other aspects are the same (including, for example, activation polarization and ohmic resistances of the anode, cathode, current collectors, and the interfacial resistances between the electrodes and the electrolyte). Using the parameters in Table 2 and Eq. 8, the cell performance of the anode-supported SOFC based on LSGM electrolyte according to a most preferred embodiment is simulated in FIG. 17. Shown in FIG. 17 is the dependence of the simulated cell voltages and power densities of the ideal anode-supported LSGM cell as a function of current densities at 650° C., 700° C., 750° C. and 800° C. The maximum power density ranges from 927 mW/cm² at 800° C. to 239 mW/cm² at 650° C.

According to one embodiment of the invention the electrolyte layer for the intermediate-temperature SOFC is strontium and magnesium doped lanthanum gallate, La_{0.9}Sr_{0.1}Ga_{0.8}Mg_{0.2}O₃, i.e., LSGM.

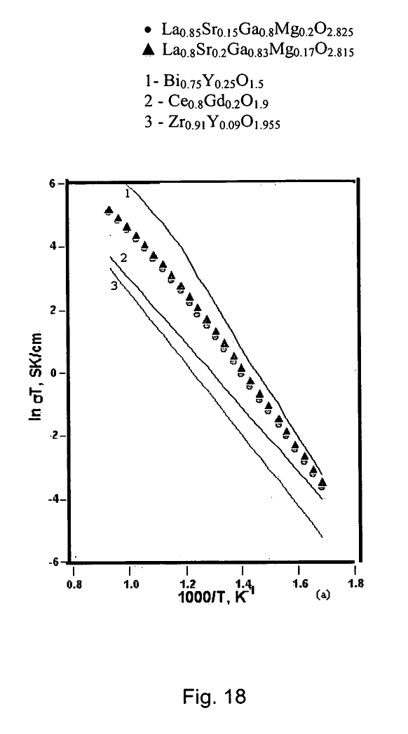

The oxygen-ion conductivity of LSGM, doped ceria, doped bismuth oxide and doped zirconia (YSZ) are compared in FIG. 18. The primary advantage of selecting LSGM as the electrolyte material is its significantly higher oxygen-ion conductivity at lower temperatures compared to the conventional YSZ electrolyte (FIG. 18). Oxygen-ion conductivity of LSGM between 500-700° C. is 0.04-0.22 S/cm and that of YSZ in the same temperature range is 0.003-0.03 S/cm. Based on the oxygen-ion conductivity criteria, LSGM has more than adequate oxygen-ion conductivity to function as a SOFC electrolyte at temperatures between 600-800° C. Even though Y₂O₃ doped-Bi₂O₃ has a higher conductivity than LSGM (FIG. 18), it is unsuitable as an electrolyte material since it is very prone to reduction to metallic Bi in reducing atmospheres and is also mechanically very fragile. The doped-CeO₂ material does not have as high oxygen-ion conductivity as the LSGM material and is prone to development of small amounts of undesired electronic conductivity on the reducing side (fuel side) of the SOFC.

LSGM is very similar to YSZ in terms of its chemical stability. In the pO₂ (oxygen partial pressure) range of 0.21 to 10⁻³⁵ atm, conditions relevant to SOFC operation, LSGM is stable and has an ionic transference number close to unity (greater than 0.99) Undoped LaGaO₃ undergoes a first-order phase transition from the orthorhombic to rhombohedral structure. This manifests itself as an abrupt and discontinuous change in the coefficient of thermal expansion at the transformation temperature (400-500° C.). However, doping it with Sr on the La sublattice and Mg on the Ga sublattice significantly suppresses this transformation and makes the shrinkage associated with the phase transition negligible. Therefore this phase transition is not of concern for the application of LSGM as an electrolyte. Based on superior oxygen-ion conductivity, negligible electronic conductivity and chemical stability under SOFC operating conditions, LSGM is chosen as the electrolyte material for the intermediate-temperature SOFC according to one embodiment of the invention.

Electrolyte powders of the composition La_{0.9}Sr_{0.1}Ga_{0.8}Mg_{0.2}O₃ (LSGM) can be prepared by mixing and ball-milling precursors of lanthanum carbonate, strontium carbonate, gallium oxide and magnesium oxide in appropriate stoichiometric ratios and calcining at a temperature of 1200° C. for 4 hours in air. The calcined powders can be lightly crushed using alumina mortar and pestle and the calcination step repeated for completing the solid-state reaction. Electrode materials such as La_{0.9}Sr_{0.1}MnO₃ (LSM), La_{0.6}Sr_{0.4}Co_{0.8}Fe_{0.2}O₃ (LSCF), Ce_{0.85}Gd_{0.15}O₂ (GDC) and Ce_{0.6}La_{0.4}O₂ (LDC) can be made using the same mixing and calcination techniques. X-ray powder diffraction analysis can be used to confirm the composition, phase and purity of the material. All the synthesized powders (LSGM, LSM, LSCF, GDC, LDC) and NiO powder can be purchased from Mallinckrodt Baker, Inc. (Phillipsburg, N.J. 08865) and are then separately ball-milled in methanol. A Laser Scattering Particle Size Distribution Analyzer (Model LA-910; Horiba Corp., Irvine, Calif., 92614) can be used periodically during the ball milling process to determine the particle size and distribution. The ball milling process can be stopped when the desired particle size and distribution is obtained.

The conductivity of synthesized LSGM electrolyte can be measured using a four-probe DC technique. The four-probe method utilizes four electrodes: two current-carrying Pt electrodes on the two ends of the sample and two Pt voltage probes in the middle of the sample. The platinum probes in the middle of the sample measure the voltage drop (V) after applying a DC current (I) through the current-carrying electrodes. This configuration allows determination of the total electrical conductivity of the sample without including the electrode impedance. The measured resistance of the middle section of the sample is:

$$\begin{matrix}R = \frac{V}{I} \\ and & ( 1 ) \\ R = \frac{1}{σ} ⨯ \frac{L}{S} & ( 2 )\end{matrix}$$

where L is the length between the two voltage probes, S is the cross section area of the sample. Thus, the conductivity of the LSGM sample

$$σ = \frac{I}{V} ⨯ \frac{L}{S} \qquad ( 3 )$$

The measured conductivities of LSGM electrolyte by four-probe method are shown in FIG. 2.

According to an embodiment of a method of symmetrical cell fabrication, calcined and milled LSGM powders at room temperature can be die-pressed at 10,000 psi pressure into pellets and sintered in air at 1450° C. for 4 hours. The sintered LSGM pellets can be 1.4 mm thick and 2 cm in diameter. The LSGM pellets can be then finely ground to a uniform 1 mm thickness using diamond-grinding discs. LSM-LSGM, LSCF-LSGM, NiO-GDC, and NiO-LDC composite electrodes are prepared by thoroughly mixing desired amounts of the powders. The electrode powders (LSM, LSM-LSGM, LSCF, LSCF-LSGM, NiO-GDC, and NiO-LDC) can be each dispersed in α-terpeniol solvent to form a paste. For the cathode electrodes (LSM, LSM-LSGM, LSCF, and LSCF-LSGM) and the anode without the barrier (buffer) layer, the ground LSGM electrolyte pellets can be masked with SCOTCH™ adhesive tape to form an outer ring on both sides and the electrode pastes painted smoothly on the open circular surfaces. The painted LSGM electrolyte pellets can be air-dried, masks removed and fired in air at elevated temperature for about 2 hours. The firing temperature is preferably about 1100° C. for the cathodes and about 1200-1300° C. for the anodes (such as, for example, the NiO-GDC and Ni-LDC electrodes). Electrodes can have an effective area of about 1.33 cm². When GDC or LDC barrier layers are employed between the Ni-doped-ceria composite anode and the LSGM electrolyte, very fine GDC or LDC powders can be dispersed in α-terpeniol solvent to form a paste which can be painted on both sides of the LSGM electrolyte. These layers can be air dried and sintered at 1200-1300° C. and the anodes then applied following the procedure described above. For the cathode materials, two pieces of platinum mesh can be co-sintered on both electrode surfaces to act as current collectors. Lead wires of Pt can be used to connect the platinum-mesh current collectors to the measuring instrument. For the anode materials, pieces of nickel mesh can be pressed over the electrode surfaces and co-sintered in a reducing atmosphere. Nickel lead wires can be used to connect the nickel-mesh current collectors to the measuring instrument.

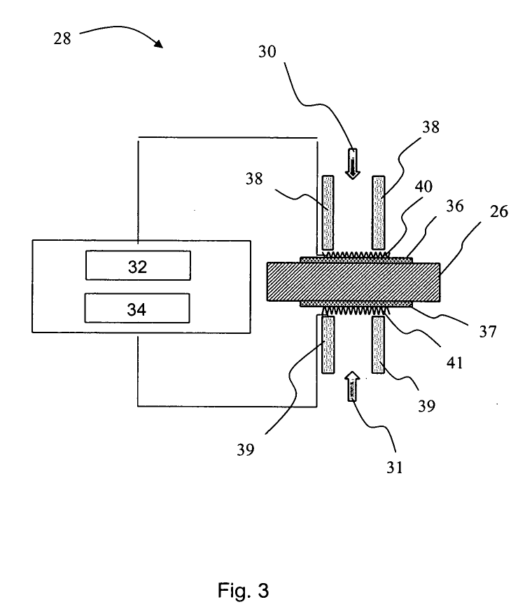

A setup using a symmetrical-cell arrangement as shown in FIG. 3 can be used to evaluate AC impedence. The symmetrical cell 28 comprises an electrolyte layer 26 adjacent on one side to an electrode 37 and collector 41 and on the other to electrode 36 and collector 40. Alumina tubes 38, 39 are positioned to deliver gases 30, 31, respectively, to the electrodes. In this setup, the symmetrical cell can be exposed to the same oxidizing (cathodic), or reducing (anodic) atmosphere on both sides and a two-probe configuration can be used to measure the impedance spectra. During evaluation measurements a constant flow rate of air is maintained for cathode materials, and a constant flow rate of forming gas (95% argon-5% hydrogen) bubbled through water at 25° C. is maintained for evaluations involving the anode materials. The measurements are made by applying a small-amplitude AC voltage (10 mV) to the cell and monitoring the response current as a function of the AC frequency (for example, from 1 mHz to 65 KHz). A plot of the imaginary component of the measured impedance versus the real component reveals details of the individual ohmic and polarization contributions to the total resistance of the cell. Referring still to FIG. 3, impedance measurements can be made in the temperature range of 600-800° C. in 50° C. increments using a Perkin-Elmer potentiostat/galvanostat 32 (Model 263A) and Solartron analytical-frequency-response analyzer 34 (Model 1250).

AC impedance evaluation measurements have been conducted for multiple embodiments of the invention, including, for example, LSCF, LSCF-LSGM, LSM-LSGM, LSM, Ni-GDC, and Ni-LDC electrodes. For the Ni-GDC electrodes, measurements have been made with and without the doped ceria (GDC or LDC) barrier layer. The Ni-LDC electrodes have been evaluated with an LDC barrier layer. After the measurements, the samples are sectioned, epoxy mounted and polished. Optical microscopy and scanning electron microscopy is used to measure the grain size, porosity and thickness of the electrodes and confirm the consistency of the microstructure. Electron microprobe analysis and wavelength dispersive spectroscopy are also used to determine diffusion profiles of the elements at the interfaces.

To characterize electrochemical aspects of multiple embodiments, well-sintered dense LSGM electrolyte discs are ground to 1 mm thickness using grinding discs with diamond particles. LDC paste is painted on one side of the LSGM electrolyte and sintered in air at 1300° C. for 4 hours to act as the barrier layer between Ni-LDC anode and LSGM electrolyte. NiO-LDC (50% by volume) composite anode paste is then painted smoothly on the LDC barrier layer surface and sintered in air at 1300° C. for 2 hours. After that, the LSCF-LSGM (50% by volume) composite cathode paste is painted on the other side of the LSGM electrolyte and sintered at 1100° C. for 2 hours. The effective electrode area of the cell is 1.33 cm², which was used for the current density calculation.

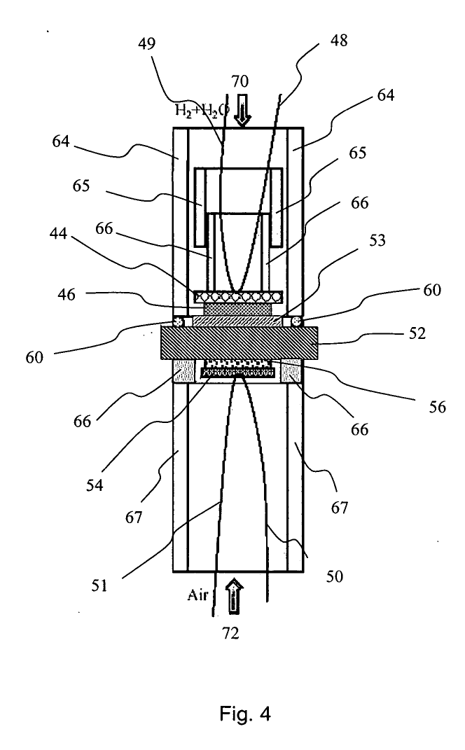

According to a further embodiment of the invention, referring now to FIG. 4, in order to decrease contact resistance at the anode, a Ni mesh current collector 44 can be pressed over an Ni-LDC anode surface 46 and two separate nickel lead wires 48, 49 (current and voltage lead wires) can be used to connect the nickel-mesh current collectors to a measuring instrument. Similarly, on the cathode side, a Pt mesh 54 can be sintered to the cathode 56 at 900° C. by using a Pt paste (sintering time 1 hour). Two separate lead wires of Pt 50, 51 (current and voltage lead wires) can be used to connect the Pt-mesh current collector 54 to the measuring instrument. Referring still to FIG. 4, a setup for evaluating the LSGM electrolyte supported SOFC includes a gold O-ring 60 positioned between the alumina tube 64 and the LSGM electrolyte 52 to seal the anode side. A thick Mica gasket 66 can be used on the cathode side as the seal. Additional alumina tubes 65, 66 can be used to direct gas 70 to the anode 46 and similar tube 67 to direct gas 72 to the cathode 56. The assembled cell can be placed in the hot zone of a vertical furnace for evaluation.

At the beginning of an evaluation, forming gas 70 (95% Ar, 5% H₂) bubbled through water at room temperature is introduced on the anode side and an airflow 72 is maintained on the cathode side. The temperature is then slowly increased to 800° C. for reduction of the NiO in the anode 46. The anode 46 of the single cells can be reduced by a stepwise replacement of the forming gas with hydrogen. The reduction can be complete in 4 hours in the hydrogen gas.

The electrochemical performance of the above embodiment has been measured between 600° C. and 800° C. in 50° C. intervals. The gas flow rate of hydrogen was 200 mL/min on the anode side and 150 mL/min. of air on the cathode side. All electrochemical data were obtained by DC methods using a Perkin-Elmer potentiostat/galvanostat (Model 263A).

Electrochemical characterization consists of measuring the open circuit potential (OCP) of the cells under SOFC operating conditions. The ratio of the measured OCP to the expected Nernst voltage provides a metric for determining the leak tightness of a cell. The current-voltage characteristics are measured with increasing current load from zero until the voltage drops below 0.4-0.5V. The electrical performance of single cells can be evaluated from the I-V plots by determining the ohmic loss and the electrode polarization losses as a function of the cell current. Evaluations can be conducted for longer times (5000 minutes) to determine performance stability. At the end of each evaluation, microstructural characterization of the cells can be performed. From these measurements, the overall stability and electrical performance of these cells can be assessed.

### EQUIVALENTS

While the invention has been described in connection with specific methods and apparatus, those skilled in the art will recognize other equivalents to the specific embodiments herein. It is to be understood that the description is by way of example and not as a limitation to the scope of the invention and these equivalents are intended to be encompassed by the claims below and as set forth in the claims.

### REFERENCES

1) S. Srinivasan, R. Mosdale, P. Stevens, and C. Yang, “Fuel Cells, “Reaching the Era of Clean and Efficient Power Generation in the twenty-First Century,” Annual Review of the Energy and the Environment, 24, Edited by R. H. Socolow, Annual Reviews, Pao Alto, Calif., 281 (1999).
2) N. Q. Minh and T. Takahashi, Science and Technology of Ceramic Fuel Cells, Elsevier Publishing Company Inc., New York (1 995).
3) B. C. H. Steele, Solid State Ionics, 75, 157, (1995).
4) N. Q. Minh, “Ceramic Fuel Cells,” J. Am. Ceram. Soc., 76(3), 563 (1993).
5) S. C. Singhal, “Recent Progress in Tubular Solid Oxide Fuel Cell Technology,” Solid Oxide Fuel Cells V, Edited by U. Stimming, S. C. Singhal, H. Tagawa and W. Lehnert, The Electrochemical Society Proceeding Series, Pennington, N.J., 37, (1997).
6) Internet Bulletin of the Solid State Energy Conversion Alliance, NETL, Pittsburgh, Pa., http://www.seca.doe.gov/Publications/seca_related_documents.htm
7) Simens Westinghouse Brochure on SureCELL (1996-2001), Science and Technology Center, 1310 Beulah Road, Pittsburgh, Pa. 15235-5098.
8) K. Huang, R. S. Tichy, and J. B. Goodenough, Journal of American Ceramic Society, 81, 2565, (1998).
9) J-H. Kim and H-I. Yoo, Solid State Ionics, 140, 105 (2001).
10) H. Inaba, H. Hayashi, and M. Suzuki, Solid State Ionics, 144, 99 (2001).
11) H. Hayashi, M. Suzuki, and H. Inaba, Solid State Ionics, 128, 131 (2000).
12) A. Petric, P. Huang, F. Tietz, Solid State Ionics, 135, 719 (2000).
13) M. T. Colomer, B. C. H. Steele and J. A. Kilner, Solid State Ionics, 147, 41 (2002).
14) X. Zhang, S. Ohara, R. Maric, H. Okawa, T. Fukui, H. Yoshida, T. Inagaki, K. Miura, Solid State Ionics, 133, 153, (2000).
15) M. Hattori, Y. Takeda, J.-H. Lee, S. Ohara, K. Mukai, T. Fukui, S. Takahashi, Y. Sakaki and A. Nakanishi, Journal of Power Sources, 131, 247 (2004).
16) Wensheng Wang and Anil V. Virkar, Journal of power Sources, 142, 1 (2005).
17) Jiho Yoo, Chan Young Park and Allan J. Jacobson, Solid State Ionics, 175, 55 (2004).
18) K. Huang and J. B. Goodenough, Journal of Alloys and Compounds, 303, 454 (2000).
19) N. Trofimenko and H. Ullmann, Solid State Ionics, 118, 215 (1999).
20) J. W. Stevenson, T. R. Armstrong, L. R. Pederson, J. Li, C. A. Lewinsohn and S. Baskaran, Solid State Ionics, 113, 571 (1998).
21) C. W. Tanner, K. Z. Fung and A. V. Virkar, J. Electrochem. Soc., 144, 21 (1997).
22) A. V. Virkar, J. Chen, C. W. Tanner and J. W. Kim, Solid State Ionics, 131, 189 (2000).
23) H. Hu and M. Liu, Solid State Ionics, 109, 259 (1998).
24) S. Wang, X. Lu and M. Liu, J. of Solid State Electrochemistry, 6, 384 (2002).
25) J. R. Macdonald, Impedance Spectroscopy: Emphasizing Solid Materials and Systems, Wiley, New York, (1987).
26) N. Q. Minh, J. Am. Ceram. Soc., 76, 563 (1993).
27) L. W. Tai, M. M. Nasrallah, H. U. Anderson, D. M. Sparlin and S. R. Sehlin, Solid State Ionics, 76, 273 (1995).
28) S. Sameshima, T. Ichikawa, M. Kawaminami, and Y. Hirata, Materials Chemistry and Physics, 61, 31 (1999).
29) M. Hrovat, A. Ahmad-Khanlou, Z. Samardzija, and J. Holc, Materials Research Bulletin, 34, 2027 (1999).
30) K. Huang, J. H. Wan, and J. B. Goodenough, J. Electrochem. Soc., 148, A788 (2001).
31) Y. Matsuzaki and I. Yasuda, Solid State Ionics, 152, 463 (2002).
32) Allen J. Bard, Larry R. Faulkner, Electrochemical Methods: Fundamentals and Applications, 2nd Edition, John Wiley & Sons, Inc, NY (2001).

What is claimed is

1. A solid oxide fuel cell having a ceramic bi-layer interconnect, comprising
a cathode layer;
a first ceramic layer consisting of a dense p-type semiconductor adjacent to the cathode layer;
a second ceramic layer consisting of a dense n-type semiconductor adjacent to the first ceramic layer opposite the cathode layer;
a barrier layer adjacent to the second ceramic layer opposite the first ceramic layer; and
an anode layer adjacent to the barrier layer opposite the second ceramic layer.

2. The fuel cell of claim 1, wherein the cathode layer is porous.

3. The fuel cell of claim 1, wherein the cathode layer is about 30 percent porous by volume and has an average grain size of about 1 micron.

4. The fuel cell of claim 1, wherein the cathode layer is about 50 percent porous by volume.

5. The fuel cell of claim 1, wherein the cathode and anode layers have a porosity between 25-35 percent by cross-sectional area.

6. The fuel cell of claim 1, wherein the cathode and anode layers have a grain size on the order of 1-2 microns.

7. The fuel cell of claim 1, wherein the cathode and anode layers have a thickness of 10-60 microns.

8. The fuel cell of claim 1, wherein the first ceramic layer comprises a dense p-type semiconductor consisting of one of acceptor doped-lanthanum manganite, including lanthanum strontium manganate (LSM), acceptor doped-lanthanum ferrite, acceptor doped-lanthanum chromite, and acceptor doped-lanthanum cobaltite, including Sr and Fe doped lanthanum cobaltite, including lanthanum strontium cobalt ferrite (LSCF).

9. The fuel cell of claim 1, wherein the second ceramic layer comprises a dense n-type semiconductor consisting of a donor doped ferroelectric material with a perovskite structure.

10. The fuel cell of claim 1, wherein the second ceramic layer comprises a dense n-type semiconductor consisting of donor doped strontium titanate (SrTiO3).

11. The fuel cell of claim 1, wherein the second ceramic layer comprises a dense n-type semiconductor consisting of A- and B-site donor doped strontium titanate (SrTiO3).

12. The fuel cell of claim 10, wherein the donor doped strontium titanate (SrTiO3) consists of Gd_{0.08}Sr_{0.88}Ti_{0.95}Al_{0.05}O_{3±δ} (GSTA) or La_{0.08}Sr_{0.88}Ti_{0.95}Al_{0.05}O_{3±δ} (GSTA).

13. The fuel cell of claim 1, wherein the barrier layer comprises a flexible metal structure layer.

14. The fuel cell of claim 1, wherein the barrier layer comprises a flexible metal structure layer consisting of Ni-felt.

15. The fuel cell of claim 1, wherein the barrier layer comprises a lanthanum doped ceria (LDC) or gadolinium doped ceria (GDC).

16. The fuel cell of claim 1, wherein the barrier layer is less than 5 micrometers in thickness.

17. The fuel cell of claim 1, wherein the barrier layer is a thin LDC barrier layer and the anode is Ni-LDC ceramic-metal composite (cermet).

18. The fuel cell of claim 1, wherein the anode layer is porous.

19. The fuel cell of claim 1, wherein the cathode layer is a porous cathode layer consisting of lanthanum strontium manganate (La₁₋ₓSrₓMnO₃ or LSM), Sr and Fe doped lanthanum cobaltite, (La₁₋ₓSrₓCo_{y}Fe_{1-y}O₃ or LSCF), two-phase particulate mixture of LSM-LSGM, or LSCF-LSGM Composite.

20. The fuel cell of claim 1, wherein the anode layer is a porous anode layer consisting of nickel-doped ceria, including Ni-GDC or Ni-LDC cermet.

21. A solid oxide fuel cell having a ceramic bi-layer interconnect and a low cell-to-cell resistance, comprising
a cathode layer;
a ceramic bi-layer interconnect consisting of a dense p-type semiconductor material layer adjacent at a bi-layer interface to a dense n-type semiconductor material layer, wherein the p-type semiconductor layer is adjacent to the cathode layer;
a barrier layer adjacent to the ceramic bi-layer opposite the cathode layer; and
an anode layer adjacent to the flexible metal structure layer opposite the ceramic bi-layer.

22. The fuel cell of claim 21, wherein an oxygen partial pressure at the bi-layer interface depends primarily on the oxygen partial pressure across the bi-layer interconnect and on the low-level oxygen conductivities of each of the conductor material layers, and the oxygen partial pressure is largely independent of electronic conductivities of each conductor material layer and of a total current density through the conductor material layers.

23. A solid oxide fuel cell having a low cell-to-cell resistance, comprising
a cathode layer consisting of LSCF-LSGM composite;
an electrolyte layer consisting of LSGM adjacent to the cathode layer;
a barrier layer adjacent to the electrolyte layer opposite the cathode layer; and
an anode layer consisting of Ni-GDC or Ni-LDC adjacent to the barrier layer opposite the electrolyte layer.

24. The fuel cell of claim 23, wherein the cell has a maximum power density as a function of temperature in the range of 190 mW/cm² at 800° C. to 3 mW/cm² at 600° C.

25. The fuel cell of claim 23, wherein the cell has a maximum power density as a function of temperature in the range 0.2-1.0 W/cm² between 650-800° C.

26. The fuel cell of claim 23, wherein the electrolyte layer is about 20 microns thick and the cell has a maximum power density of 927 mW/cm² at 800° C. and 239 mW/cm² at 650° C.

27. The fuel cell of claim 23, wherein the cathode layer consists of about 50/50 volume composite LSCF-LSGM having a fine microstructure of about 1-2 micron grains, with porosity of about 25-35% by cross-sectional area and thickness of about 30-40 microns.

28. The fuel cell of claim 23, wherein the cathode layer has a polarization resistance as a function of temperature at an interface between the cathode and the electrolyte layers is in the range of about 4.5-9.0 Ln(T/Rₚ/ohm⁻¹cm⁻²K) between 650-1075° C., respectively.

29. The fuel cell of claim 23, wherein the electrolyte layer is about 1 mm thick.

30. The fuel cell of claim 23, wherein the barrier layer is LDC and is about 5 microns thick.

31. The fuel cell of claim 23, wherein the anode layer is 50% by volume of Ni-LDC composite having a thickness of 1-2 mm and (cross-sectional) porosity of 25-35%.

32. The fuel cell of claim 25, wherein the cell achieves open circuit voltages (OCV) of about 1.118 at 800° C.

33. The fuel cell of claim 23, wherein the barrier layer is LDC and is about 5 microns thick, and wherein the electrolyte layer is a ceramic bi-layer interconnect consisting of a dense p-type semiconductor material layer adjacent at a bi-layer interface to a dense n-type semiconductor material layer, wherein the p-type semiconductor layer is adjacent to the cathode layer.

34. The cell of claim 1, 21 or 23, wherein at least one of the cathode and anode layers have a graded electrode structure with a finer microstructure. According to an embodiment of the invention, to achieve a balance between these two conflicting requirements, graded electrode structures with a finer microstructure and porosity close to the electrolyte and coarser microstructure and larger porosity away from the electrolyte can be provided for the supporting electrode.

35. For instance, for an anode-supported SOFC, the fine electrode microstructure close to the electrolyte can have a large three-phase-boundary (ionic-electronic-gas) length and facilitate charge-transfer reactions and the coarser microstructure and porosity of the thicker outer anode layer can facilitate gas transport. According to one embodiment of the invention a fine microstructure is needed at the electrode interface with the electrolyte.

36. The cell of claim 1, 21 or 23, wherein at least one of cathode and anode has critical thickness of about 40 μm. Based on cathode microstructure according to one embodiment, a thickness of 40 μm is sufficient to minimize the interfacial polarization resistance; thus, the cathode layer is most preferably about 40 μm thick.

37. The cell of claim 1, 21 or 31 wherein 50% by volume of Ni-LDC composite anode having a fine microstructure near the LDC buffer layer and coarser microstructure away from the barrier (buffer) layer; porosity 25-35%. Since the design is based on an anode-supported cell, the anode can be 1-2 mm thick and the fine microstructure region at least 30-40 μm thick.
